(19) United States
(12) Patent Application Publication
(10) Pub. No.: US 2024/0255669 A1
(43) Pub. Date: Aug. 1, 2024

(54) SYSTEM AND METHOD FOR TESTING WELL INTEGRITY

(71) Applicant: CHEVRON U.S.A. INC., San Ramon, CA (US)

(72) Inventors: Ivan LIM CHEN NING, Houston, TX (US); Michael Eric CRAVEN, Katy, TX (US); Saptarshi DASGUPTA, Houston, TX (US); Timothy John TOKAR, The Woodlands, TX (US)

(73) Assignee: CHEVRON U.S.A. INC., San Ramon, CA (US)

(21) Appl. No.: 18/414,853

(22) Filed: Jan. 17, 2024

Related U.S. Application Data
(60) Provisional application No. 63/481,767, filed on Jan. 26, 2023.

(51) Int. Cl. G01V 1/50

(52) U.S. Cl. CPC G01V 1/50; G01V 2210/121

(57) ABSTRACT

A method is described for determining well integrity including deploying seismic sensors in a wellbore; attaching a vibrational source to well hardware; using the vibrational source to generate seismic signal that moves through the wellbore; creating a seismic dataset by recording the seismic signal at the seismic sensors; and processing the seismic dataset to make a processed seismic image. The processed seismic image may be displayed on a graphical display in order to identify well integrity problems such as wellbore deformation, well casing damage, or problems with cement.

### CROSS-REFERENCE TO RELATED APPLICATIONS

This application claims the benefit of U.S. provisional patent application 63/481,767 entitled “System and Method for Testing Well Integrity”, filed Jan. 26, 2023.

### STATEMENT REGARDING FEDERALLY SPONSORED RESEARCH OR DEVELOPMENT

Not applicable.

### TECHNICAL FIELD

The disclosed embodiments relate generally to techniques for testing well integrity. In particular, the techniques evaluate the structure of the well casing and cement to identify possible well deformation and/or fluid leakage.

### BACKGROUND

Historically, well integrity has been tested using Cement Bond Logs (CBL) that acoustically measure the quality of cement's ability to fully occupy and prevent liquid and gas movement in void space around the well casing. The CBL works like a sonic tool by putting acoustic energy such as a hammer strike into the casing and measuring the resonance vibration from these acoustic signals and the casing. A well-cemented section of casing with all void space fully occupied and sealed will absorb the acoustic energy and a lack of cement occupying and sealing all void space will result in casing vibrations or higher resonance which is sensed on the CBL. The cement's ability to form a high-quality seal in all void space can then be displayed along the length of casing. This information is used to determine what, if any, remediation action is required or where plugs and barriers should be set as part of the decommissioning exercise. A key point is to identify the top of cement in depth.

There exists a need for methods to determine well integrity in order to prevent undesired fluid or gas movement into or out of the well. Historically this is done using Spectral Noise Logging (SNL). The SNL utilizes an acoustic detector to identify potential inflow for profiling or leak detection. The acoustic detector is lowered at specifical intervals along the wellbore to passively record acoustic signatures. The recorded signals are transformed into the frequency domain to perform spectral analysis. This information is utilized in analyzing conditions such as the reservoir fluid composition and cross-flow behind casing which lacks cement completely occupying void space or with a poor seal.

### SUMMARY

In accordance with some embodiments, a method of determining well integrity including deploying seismic sensors in a wellbore; attaching a vibrational source to an exterior or interior section of well hardware; using the vibrational source to generate seismic signal that moves through the wellbore; creating a seismic dataset by recording the seismic signal at the seismic sensors; processing the seismic dataset to make a processed seismic image; generating a graphical representation of the processed seismic image; and displaying the graphical representation on a graphical display is disclosed. The method of claim 1 wherein the seismic sensors are a distributed acoustic sensing (DAS) fiber. In an embodiment, the vibrational source is a speaker. In another embodiment, the vibrational source is a percussive source using planned metallic collisions. In yet another embodiment, the seismic signal sweeps across frequencies from 10 Hz to 360 Hz. In some embodiments, the processing includes source de-signature. In embodiments including source de-signature, the source de-signature may be cross-correlation of the seismic signal and the seismic dataset. The method may also identify at least one of wellbore deformation, well casing damage, or problems with cement.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for determining well integrity;

FIG. 2 illustrates a workflow for determining well integrity;

FIG. 3 shows an example of raw seismic data recorded in the example system for determining well integrity;

FIG. 4 illustrates a step of a method for determining well integrity; and

FIG. 5 illustrates a step of a method for determining well integrity.

Like reference numerals refer to corresponding parts throughout the drawings.

### DETAILED DESCRIPTION OF EMBODIMENTS

Described below are methods, systems, and computer readable storage media that provide a manner of testing well integrity. These embodiments are designed to be of particular use for identifying possible well deformation and/or fluid leakage.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

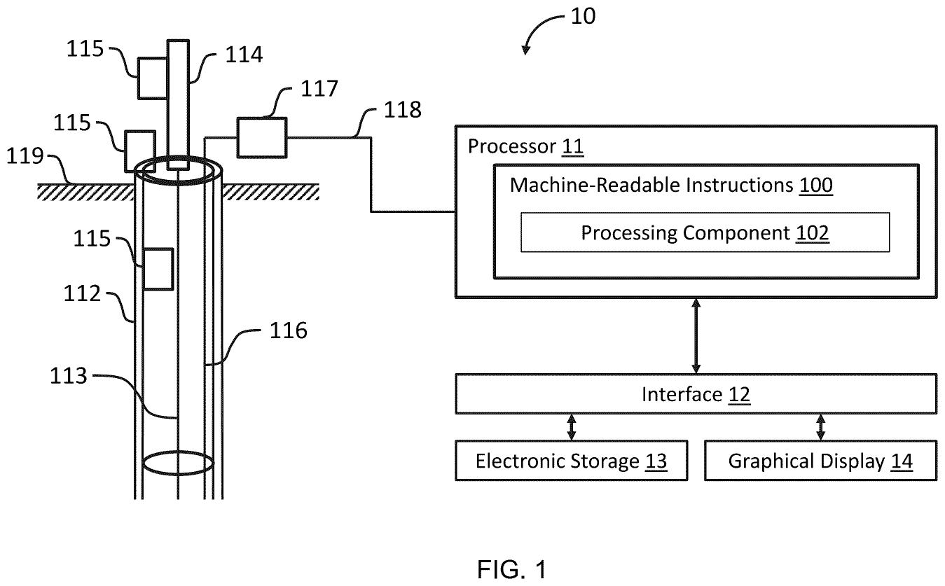

The methods and systems of the present disclosure may be implemented by a system and/or in a system, such as a system 10 shown in FIG. 1. The system may include multiple well casing sections 112 installed in a wellbore with some lengths cemented inside the wellbore; a well head 114 suspending a well string 113, a vibrational source 115 (eg. acoustic and/or resonant and/or percussive source) attached to the exterior or interior of the well, eg., the well head 114 and/or exterior and interior well casing sections 112, an array of seismic sensors 116 disposed in the wellbore which may be a distributed acoustic sensing (DAS) array, a seismic receiver 117 which may be a DAS interrogator, and a data interface 118. The well head 114 and the well casing sections 112 may be collectively referred to as well hardware. 119 demarks ground level for a land based well, and the mud line for a well in an offshore body of water. The array of seismic sensors 116 disposed in the wellbore may be deployed permanently, such as in cement between the well casing sections 112 and the surrounding rock formations, or temporarily such as inside the well casing sections 112 or strapped to the well casing sections 112.

The system 10 may further include one or more of a processor 11, an interface 12 (e.g., bus, wireless interface), an electronic storage 13, a graphical display 14, and/or other components. Processor 11 receives the recorded seismic signal via data interface 118 and produces a graphical representation of the integrity of the wellbore.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to seismic data, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to well integrity, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate processing seismic data representative of well integrity. The machine-readable instructions 100 may include one or more computer program components. The machine-readable instructions 100 may include a processing component 102 and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the processing component 102 may be configured to process the recorded seismic data in order to identify signal generate by the acoustic sources such as tube waves that travel within the well casing. The reflections of the tube waves may contain information on the wellbore and/or the rock formation surrounding the wellbore.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

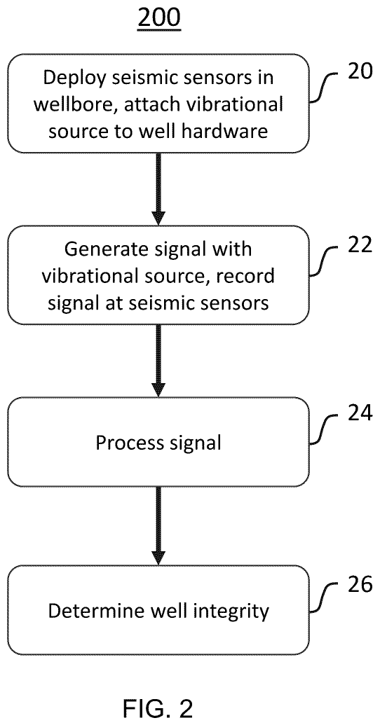

FIG. 2 illustrates an example process 200 for determining well integrity. At step 20, seismic sensors are deployed in the wellbore and one or more vibrational sources (acoustic and/or resonant and/or percussive) are attached to the well hardware, such as connected to the wellhead or in contact with the interior or exterior of the well casing. In an embodiment, the seismic sensors may be a distributed acoustic sensing (DAS) fiber. In the same or another embodiment, the vibrational source(s) may be an acoustic speaker, a resonant speaker, or percussive.

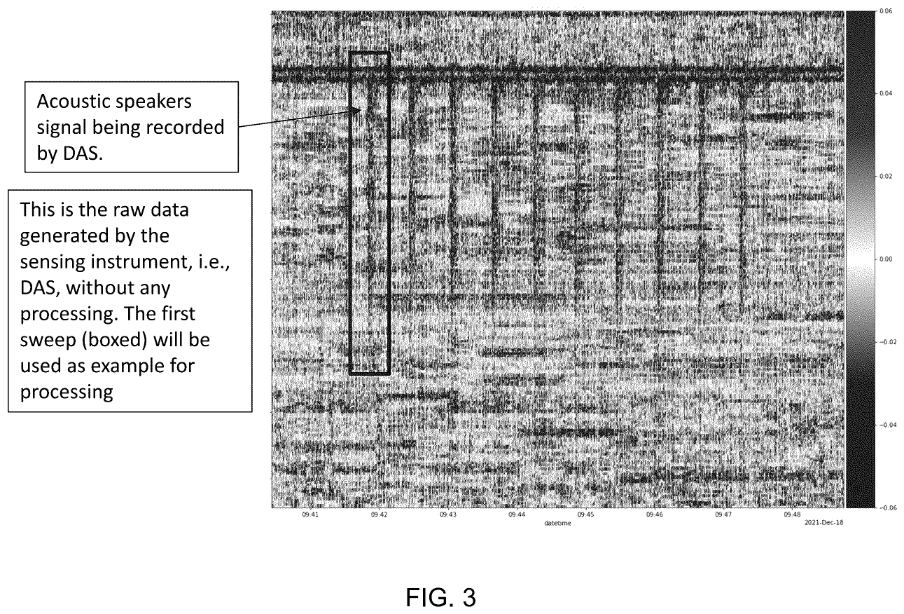

At step 22, the vibrational source(s) generates a pre-determined signal such as sine waves that may optionally be amplified via an acoustic audio amplifier. The vibrational source(s) may emit the signal at a constant frequency, at various frequencies, or as a frequency sweep across a range of frequencies, such as from 10 Hz to 360 Hz. The seismic signal will transmit along the wellbore as, for example, a tube wave. The seismic signal may reflect at places in the wellbore where the wellbore is deformed, the cement quality varies, or the surrounding rock formation has property changes. The seismic signal and any reflections of the seismic signal are recorded by the seismic sensors. An example of seismic data recorded at the seismic sensors is shown in FIG. 3.

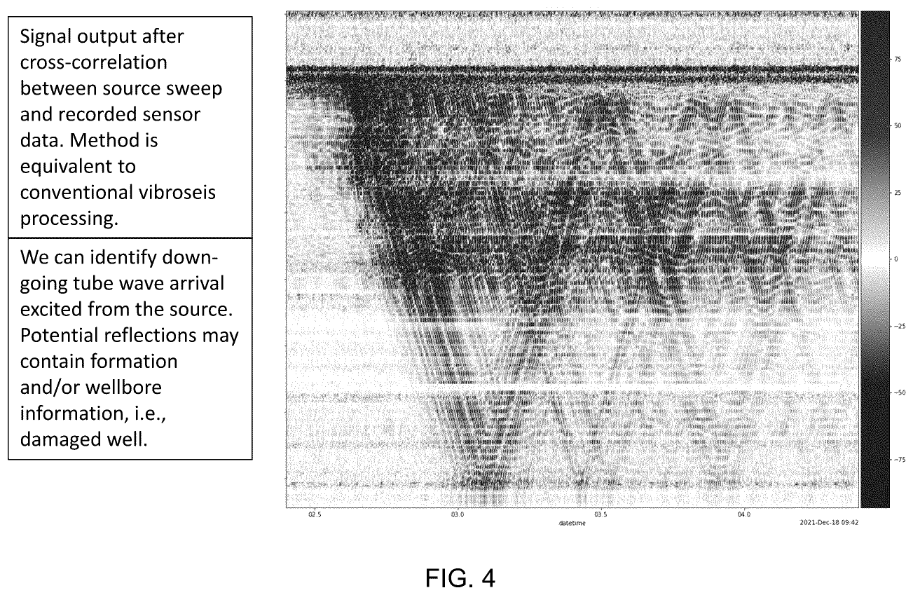

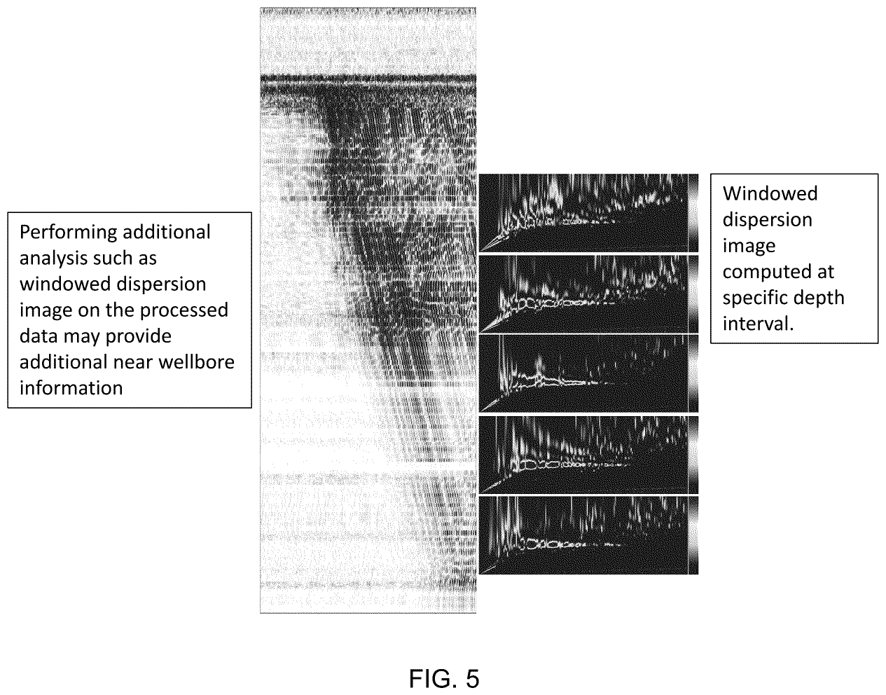

At step 24, the recorded seismic signal is processed. This may include, by way of example and not limitation, cross-correlation or deconvolution between a known source sweep or signature and the recorded seismic data, as shown in FIG. 4 to remove the source signature (i.e., de-signature) from the recorded signal to enable analysis of the signals relating to the wellbore only. Further improvement on the signal-to-noise ratio can be achieved by repeating the vibrational source acquisition multiple times and followed by stacking (e.g., summing the point-by-point values in the images). It may further include additional subsequent processing steps that include mathematical transforms such as a windowed dispersion image, as shown in FIG. 5.

At step 26, the processed data is used to determine well integrity. This may be done, for example, by displaying the processed data along the wellbore to observe reflection events that indicate changes in the wellbore. The display in FIG. 5 demonstrates this, with the windowed dispersion image computed at specific depth intervals.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of determining well integrity, comprising:
a. deploying seismic sensors in a wellbore;
b. attaching a vibrational source to an exterior or interior section of well hardware;
c. using the vibrational source to generate seismic signal that moves through the wellbore;
d. creating a seismic dataset by recording the seismic signal at the seismic sensors;
e. processing the seismic dataset to make a processed seismic image;
f. generating a graphical representation of the processed seismic image; and
g. displaying the graphical representation on a graphical display.

2. The method of claim 1 wherein the seismic sensors are a distributed acoustic sensing (DAS) fiber.

3. The method of claim 1 wherein the vibrational source is a speaker.

4. The method of claim 1 wherein the vibrational source is a percussive source using planned metallic collisions.

5. The method of claim 1 wherein the seismic signal sweeps across frequencies from 10 Hz to 360 Hz.

6. The method of claim 5 wherein the processing includes source de-signature.

7. The method of claim 6 wherein the source de-signature is cross-correlation of the seismic signal and the seismic dataset.

8. The method of claim 1 further comprising identifying at least one of wellbore deformation, well casing damage, or problems with cement.
